(19) United States
(12) Patent Application Publication
(10) Pub. No.: US 2009/0046039 A1
(43) Pub. Date: Feb. 19, 2009

(54) PLASMA DISPLAY PANEL AND METHOD FOR MANUFACTURING THE SAME

(75) Inventors: Yong Sin Kim, Uiwang-si (KR); Jung Hoan Kim, Uiwang-si (KR); Kwang Seon Lee, Uiwang-si (KR); In Yong Lee, Uiwang-si (KR)

Correspondence Address: KED & ASSOCIATES, LLP, P.O. Box 221200, Chantilly, VA, 20153-1200, US

(73) Assignee: LG Electronics Inc.

(21) Appl. No.: 12/110,413

(22) Filed: Apr. 28, 2008

(30) Foreign Application Priority Data
Aug. 14, 2007 (KR) 1020070081784

(51) Int. Cl. G09G 3/28

(52) U.S. Cl. 345/71

(57) ABSTRACT

A plasma display panel and a method for manufacturing the same ate provided. The plasma display panel includes a first substrate, a second substrate, and a drive device. The first substrate includes at least one address electrode, a dielectric layer, phosphors, and at least one barrier rib. The second substrate may be bonded to the first substrate with the at least one barrier ribs between the first and second substrates. The second substrate includes at least one pair of sustain electrodes, a dielectric layer, and a protective layer including a single crystal magnesium oxide nano powder. The drive device provides at least one of a ramp-up or a ramp-down waveform, wherein at least one of (1) the ramp-up waveform has a different peak voltage based on the temperature of the plasma display panel or (2) the ramp-down waveform has a different lowest voltage based on the temperature of the plasma display panel.

This application claims priority to Korean Patent Application No. 10-2007-0081784, filed on Aug. 14, 2007, which is hereby incorporated by reference in its entirety.

### BACKGROUND

### Field

A plasma display panel and a method for manufacturing the same are disclosed herein.

### BACKGROUND

Plasma display panels are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 illustrates a discharge cell structure of a plasma display panel according to an embodiment;

FIG. 2 illustrates a drive device of a plasma display panel according to an embodiment;

FIG. 3 illustrates control signals generated by a set-down control signal generator shown in FIG. 2;

FIG. 4 illustrate how the plasma display panel is driven by the drive device shown in FIG. 2; and

FIGS. 5A to 5K illustrate a method for manufacturing a plasma display panel according to embodiment.

### DETAILED DESCRIPTION

Reference will now be made in detail to embodiments, examples of which are illustrated in the accompanying drawings. Wherever possible, like reference numbers have been used throughout the drawings to refer to like parts, and repetitive disclosure has been omitted.

With the advent of the multimedia era, there has been a demand to provide a display capable of displaying colors closer to natural colors. Since Cathode Ray Tube (CRTs) have limitations in providing a screen greater than 40 inches, Liquid Crystal Displays (LCDs), Plasma Display Displays (PDPs), and projection televisions (TVs) have been developed rapidly to extend their applications to high-quality video fields.

The plasma display panel is an electronic device that displays images using plasma discharges. A specific voltage is applied across electrodes arranged in each discharge space in the panel to cause plasma discharges between the electrodes. The plasma discharge generates vacuum ultraviolet (VUV) radiation, which excites a phosphor layer formed in specific patterns to produce images.

However, an upper dielectric layer provided on an upper panel or substrate of the plasma display panel may be worn away by impacts from positive ions during discharge of the panel. A metal material, such as Na, may short the electrodes.

Thus, a protective layer is formed on the upper dielectric layer on the upper panel. The protective layer may be formed by coating magnesium oxide (MgO) on the dielectric layer that endures impacts from positive ions very well and has a high secondary electron emission coefficient.

The duration in which the plasma display panel operates is divided into a reset period, an address period, and a sustain period. In the reset period, a ramp-up waveform is applied simultaneously to scan electrodes. In the address period, a negative scan pulse is applied sequentially to the scan electrodes and positive data pulses are applied to address electrodes in synchronization with the scan pulse. In the sustain period, a sustain pulse is applied alternately to the scan and sustain electrodes.

Related art display panels have at least the following problems.

When a voltage is applied to electrodes to dissociate discharge gases to form plasma, ions in the plasma are incident on the protective layer causing secondary electrons to be emitted from the surface of the protective layer. Thus, the protective layer contributes to decreasing the voltage at which gas discharge occurs. That is, the protective layer not only endures impacts from positive ions very well but also slightly decreases the discharge start voltage. Accordingly, use of the protective layer decreases the operating voltage of the plasma display panel. The reduction in the operating voltage reduces power consumption of the panel, thereby reducing manufacturing costs and improving luminance and discharge efficiency.

However, MgO, which is currently used as the material of the protective layer, does not effectively reduce the discharge voltage due to certain characteristics of MgO, specifically because its secondary electron emission coefficient of ions incident from plasma is low.

Using MgO to form the protective layer may also degrades jitter characteristics. This may reduce the image quality since a time interval that can be allocated to the sustain period in one frame when the plasma display panel operates is insufficient. This problem is significant especially at low temperatures. Erroneous bright-defect discharges occur in the related art plasma display panel when it operates at low temperatures from ˜20° C. to 20° C. More specifically, the low temperature reduces the movement of particles so that erasure ramp waveforms may not properly generate erasure discharges. If erasure discharges are not properly generated, wall charges formed on sustain electrodes may not be properly erased in discharge cells.

If wall charges are not properly erased, discharges do not normally occur in a set-up period since there are negative wall charges formed on scan electrodes. Discharges also do not normally occur in a set-down period subsequent to the set-up period. That is, erroneous bright-defect discharges occur in the sustain period, since wall charges formed in discharge cells are not properly removed. Further, normal discharges are not generated in an initialization period of discharge cells having blue and green phosphors increasing the frequency of the occurrence of erroneous bright-defect discharges, since the discharge start voltage of the discharge cells having blue and green phosphors is set to be slightly higher than that of discharge cells having red phosphors.

In the drawings, a variety of layers and regions are shown with large thicknesses to clearly represent them, however, the ratio of the thicknesses of the layers shown in the drawings does not represent their actual thickness ratio. When one portion such as a layer, a film, a region, or a panel is described formed or located “con” another portion, the description should be understood such that one portion may not only be formed directly on another portion but also may be formed on it with another portion interposed between them.

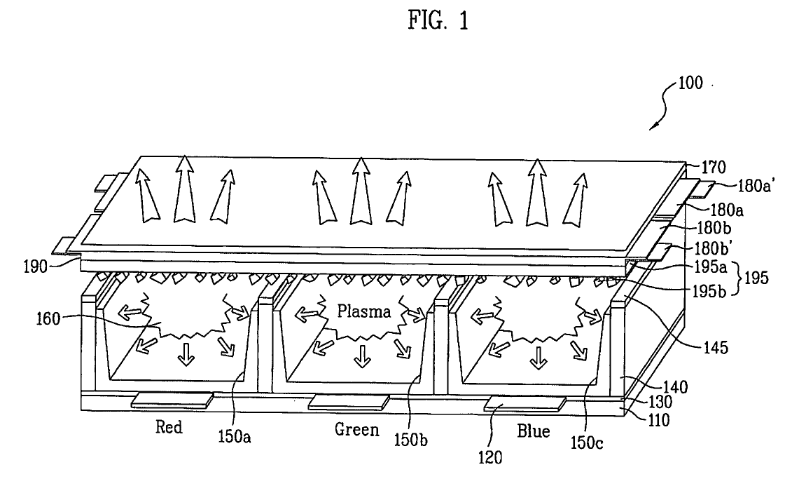

A plasma display panel according to an embodiment may include a panel portion formed by laminating upper and lower panels or substrates together and a drive device that provides drive signals to the panel portion. Reference will now be made to an embodiment of a plasma display panel according to an embodiment, shown in FIG. 1.

As shown in FIG. 1, the plasma display panel 100 according to an embodiment may include a first or front panel or substrate 170 on which a pair of sustain electrodes, one of which may include a pair of transparent and bus electrodes 180a and 180a′ and the other of which may include a pair of transparent and bus electrodes 180b and 180b′, may be formed extending in a specific direction. The transparent electrodes 180a and 180b may be formed of Indium Tin Oxide (ITO) and the bus electrodes 180a′ and 180b′ may be formed of a metal material. A dielectric layer 190 and a protective layer 195 may be sequentially formed on an entire surface of the front panel 170, covering the pair of sustain electrodes.

The front panel 170 may be formed of display substrate glass by processes, such as milling and cleaning. The transparent electrodes 180a and 180b may be formed of ITO or SnO2 by, for example, a photo-etching method using sputtering or through a lift-off method using CVD. The bus electrodes 180a′ and 180b′ may be formed of Ag or a similar material. A black matrix, which may include low melting point glass, a black dye, and similar material, may be formed on the pair of sustain electrodes.

A dielectric layer 190 may be formed on the front panel 170 including the transparent and bus electrodes 180a, 180a′, 180b, 180b′. The dielectric layer 190 may be formed of a material such as transparent low melting point glass. A detailed composition of the dielectric layer 190 will be described hereinafter. A protective layer 195 including magnesium oxide or a similar material may be formed on the front panel dielectric layer 190 to protect the dielectric layer 190 against impacts from positive ions during discharge and also to increase secondary electron emission. Details of the protective layer will be described herein below.

The protective layer 195 according to this embodiment may include a first film 195a, which may be formed of a material such as a magnesium oxide film, and a second film 195b which may be formed on the first film 195a. The second film 195b may include a powder of single crystal MgO nano particles. The single crystal MgO nano powder may have a highest level of cathode luminescence in a range of ˜200-500 nanometer wavelengths. The first film 195a may be formed to a thickness of ˜500-800 nm and the second film 195b may be formed to a thickness of ˜100 nm-1.5 μm. The second film 195b may be formed using a powder of single crystal MgO nano particles having a size of ˜50-1000 nm.

The protective layer 195 may have a degree of purity equal to or higher than ˜95% and a dopant including crystalline oxide may be added to the protective layer. The crystalline oxide may be selected from the group consisting of SiO2, TiO2, Y2O3, ZrO2, Ta2O5, ZnO, La2O3, CeO2, Eu2O3, and Gd2O3. The crystalline oxide may be alkali metal oxide or alkaline earth metal oxide. The crystalline oxide may have a weight ratio of ˜0-10% in the first film 195a.

The entire surface of the protective layer 195 may be uneven and rough since particles of the single crystal MgO nano powder may be formed in groups on specific portions of the first film 195a to form the second protective film 195b on the first film 195a. Accordingly, the surface area of the protective layer 195 with which UV ions collide during gas discharge of the plasma display panel may be increased so that the amount of secondary electrons emitted may be increased and the discharge start voltage may be reduced, thereby increasing the discharge efficiency and reducing the jitter.

On the other hand, address electrodes 120 may be formed on one surface of a second or rear panel or substrate 110 in a direction crossing the pair of sustain electrodes and a white dielectric layer 130 may be formed on the entire surface of the rear substrate 110, covering the address electrodes 120. The white dielectric layer 130 may be formed by, for example, through baking after it is coated through a printing method or a film laminating method. The dielectric layer included in the first panel may have an uneven surface. Barrier ribs 140 may be formed between the address electrodes 120 on the white dielectric layer 130. The barrier ribs 140 may be, for example, a strip, well, or delta type.

Black tops 145 may be formed on the barrier rib 140. Red (R), green (G), or blue (B) phosphor layers 150a, 150b, and 150c may be formed between the barrier ribs 140. Thus, discharge cells may be formed at intersections of the address electrodes 120 on the rear panel 110 and the pair of sustain electrodes on the front panel 170.

Reference will now be made to an embodiment of a drive device of a plasma display panel according to an embodiment.

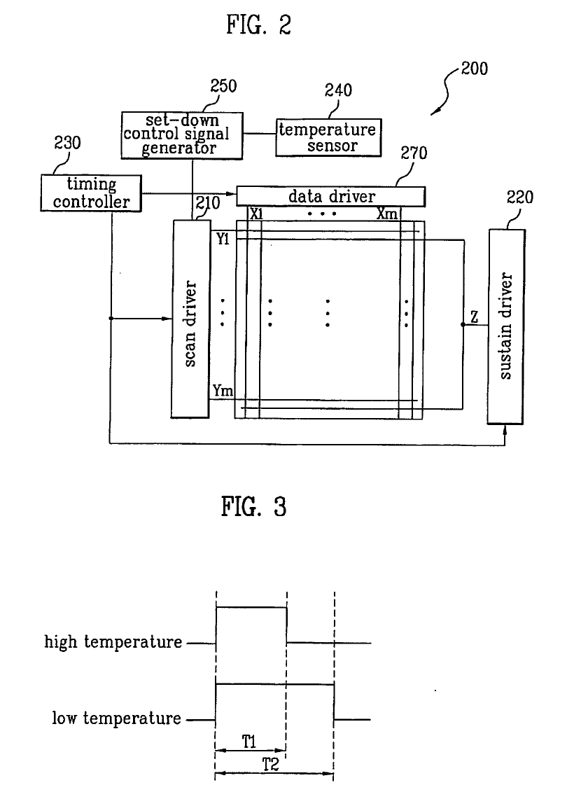

As shown in FIG. 2, the drive device 200 may include a data driver 270, a scan driver 210, a sustain driver 220, a timing controller 230, a temperature sensor 240, and a set-down control signal generator 250. The data driver 270 may apply data pulses to address electrodes X1 to Sm. The scan driver 210 may provide a ramp-up waveform, a ramp-down waveform, a scan pulse, and a sustain pulse to scan electrodes Y1 to Ym. The sustain driver 220 may apply a sustain pulse and a DC voltage to common sustain electrodes Z.

The timing controller 230 may control the data driver 200, the scan driver 210, the sustain driver 220, the temperature sensor 240, and the set-down control signal generator 250. The temperature sensor 240 may measure an ambient temperature of the panel in operation and provide a bit signal to the set-down control signal generator 250. The set-down control signal generator 250 may provide a control signal corresponding to the bit signal to the scan driver 210.

Reference will now be made in detail to how the drive device of the plasma display panel operates. First, the temperature sensor 240 may generate and provide a specific bit signal, for example, a 4-bit signal, to the set-down control signal generator 250. The temperature sensor 240 generates different bit signals at low and high temperatures. For example, the temperature sensor 240 may generate and provides a bit signal “0000” when the ambient temperature of the panel in operation is high. Upon receiving the bit signal “0000” from the temperature sensor 240, the set-down control signal generator 250 may provide a control signal having a period TI to the scan driver 210, as shown in FIG. 3.

Upon receiving the control signal having the period Ti from the set-down control signal generator 250, the scan driver 210 may provide a ramp-up waveform to the scan electrodes Y for a time T1. The ramp-up waveform may increase up to a first peak voltage Vr1 while generating a number of minute discharges in the discharge cells, thereby generating wall charges in the discharge cells.

On the other hand, the temperature sensor 240 may provide a bit signal “0011” to the set-down control signal generator 250 when the ambient temperature of the panel in operation is low. In this embodiment, the ambient temperature may be defined as being low if it is lower than the normal temperature although the low and high temperatures may be defined differently according to settings. The bit signals “0000” and “0011” are just examples to illustrate that a different control signal may be provided according to the temperature; other bit signals may also be appropriate.. Upon receiving the bit signal “0011” from the temperature sensor 240, the set-down control signal generator 250 may provide a control signal having a period T2 to the scan driver 210, as shown in FIG. 3.

Upon receiving the control signal having the period T2 from the set-down control signal generator 250, the scan driver 210 may provide a ramp-up waveform to the scan electrodes Y for a time T2. The ramp-up waveform may increase up to a second peak voltage Vr2 while generating a number of minute discharges in the discharge cells, thereby generating wall charges in the discharge cells. That is, when the plasma display panel operates at a low temperature, the voltage level of the ramp-up waveform may be set high to cause stable set-up discharges in the discharge cells.

If the ambient temperature of the panel in operation is lower than ˜0° C., the temperature sensor 240 may generate and provide a bit signal higher than “0111” to the set-down control signal generator 250. Then, the set-down control signal generator 250 may provide a control signal having a period longer than T2 to the scan driver 210. Similarly, as the ambient temperature of the panel in operation increases above ˜0° C., the temperature sensor 240 may generate and provide a bit signal having a decreasing value, below “0111”, to the set-down control signal generator 250. Then, the set-down control signal generator 250 may provide a control signal having a period between TI and T2 to the scan driver 210.

That is, in this embodiment, the high temperature may be divided into a plurality of low temperature levels and a ramp-up waveform having a higher voltage level may be provided to the scan electrodes as the temperature level decreases.

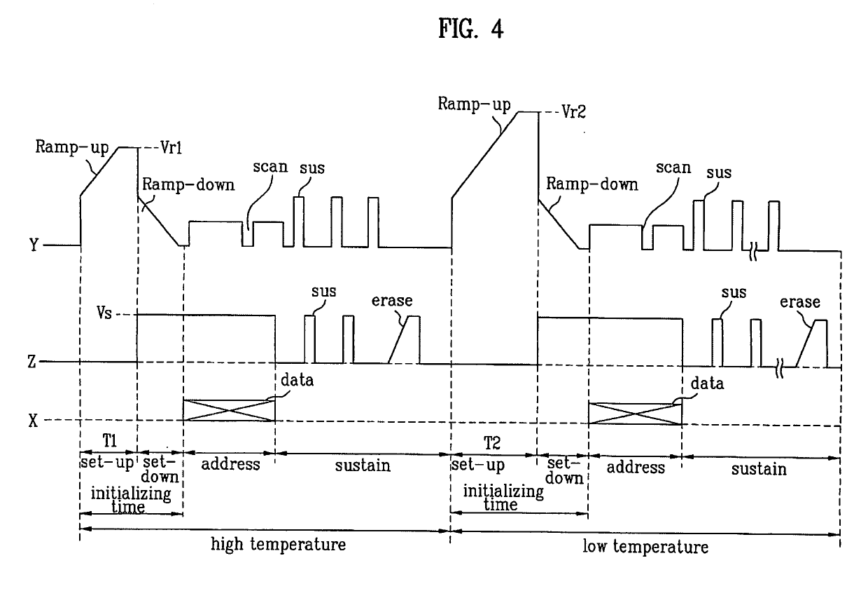

Reference will now be made to a method for driving a plasma display panel according to an embodiment with reference to FIG. 4. FIG. 4 illustrates how the plasma display panel is driven by the drive device shown in FIG. 2.

In this embodiment, a drive pulse provided to the plasma display panel at a low temperature may be different from that provided at a high temperature. First, when the plasma display panel operates at a high temperature, a duration during which it operates may be divided into an initialization period in which an entire screen may be initialized, an address period in which cells may be selected, and a sustain period in which the selected cells may be maintained in a discharged state.

A ramp-up waveform may be applied simultaneously to the scan electrodes Y in a set-up period in the initialization period. The ramp-up waveform causes minute discharges in the discharge cells of the entire screen, thereby generating wall charges in the discharge cells. The ramp-up waveform may increase up to a first peak voltage Vr1.

A ramp-down waveform may be applied to the scan electrodes Y in a set-down period in the initialization period. The ramp-down waveform causes minute erasure discharges in the discharge cells to erase unnecessary charges among the wall charges generated by the set-up discharge and/or space charges and to leave uniform wall charges required for address discharge in the discharge cells of the entire screen.

In the address period, a negative scan pulse may be applied sequentially to the scan electrodes Y while a positive data pulse may be applied to the address electrodes X. The voltage difference between the scan pulse and the data pulse and the wall voltage generated in the initialization period may be added to cause address discharges in the discharge cells to which the data pulse has been applied. Then, wall charges may be generated in discharge cells selected by the address discharge. In the set-down period and the address period, a positive DC voltage at a sustain voltage level Vs may be provided to the common sustain electrodes Z.

In the sustain period, a sustain pulse “sus” may be applied alternately to the scan electrodes Y and the common sustain electrodes Z. Then, in each of the discharge cells selected by the address discharge, each time a sustain pulse “sus” is applied, the wall voltage in the cell and the sustain pulse may be added to cause sustain discharges in the form of a surface discharge between the scan electrode Y and the common sustain electrode Z. Finally, after the sustain discharge is completed, an erasure ramp waveform “erase” with a small pulse width may be provided to the common sustain electrodes Z to erase wall charges in the discharge cells.

When the plasma display panel operates at a low temperature, a duration during which it operates may be divided into an initialization period in which the entire screen is initialized, an address period in which cells may be selected, and a sustain period in which the selected cells may be maintained in a discharged state.

A ramp-up waveform may be applied simultaneously to all scan electrodes in a set-up period in the initialization period. The ramp-up waveform causes minute discharges in the cells of the entire screen, thereby generating wall charges in the cells. The ramp-up waveform applied to the scan electrodes when the plasma display panel operates at the low temperature may increase up to a second peak voltage Vr2 higher than the first peak voltage Vr1. Specifically, a slope of the ramp-up waveform provided at the high temperature may be equal to that of the ramp-up waveform provided at the low temperature. However, the ramp-up waveform at the high temperature may be provided during the first time T1, whereas the ramp-up waveform at the low temperature may be provided during a second time T2 longer than the first time T1. Therefore, the level of the peak voltage Vr2 of the ramp-up waveform provided at the low temperature may be set to be higher than that of the peak voltage Vr1 of the ramp-up waveform provided at the high temperature.

If a high peak voltage is provided to the scan electrodes when the plasma display panel operates at a low temperature as described above, the voltage difference between the scan electrodes and the common sustain electrodes may be high to cause stable minute discharges in the cells.

In the set-down period, a ramp-down waveform, which may drop from a positive voltage lower than the peak voltage of the ramp-up waveform, may be applied simultaneously to the scan electrodes after the ramp-up waveform is applied. The ramp-down waveform causes minute erasure discharges in the cells to erase unnecessary charges among the wall charges generated by the set-up discharge and/or space charges and to leave uniform wall charges required for address discharge in the cells of the entire screen.

In the address period, a negative scan pulse may be applied sequentially to the scan electrodes while a positive data pulse may be applied to the address electrodes. The voltage difference between the scan pulse and the data pulse and the wall voltage generated in the initialization period may be added to cause address discharges in the cells to which the data pulse has been applied. Then, wall charges may be generated in cells selected by the address discharge.

In the set-down period and the address period, a positive DC voltage at a sustain voltage level Vs may be provided to the common sustain electrodes Z.

In the sustain period, a sustain pulse may be applied alternately to the scan electrodes and the common sustain electrodes. Then, in each of the cells selected by the address discharge, each time a sustain pulse may be applied, the wall voltage in the cell and the sustain pulse may be added to cause sustain discharges in the form of a surface discharge between the scan electrode and the common sustain electrode. Finally, after the sustain discharge is completed, an erasure ramp waveform with a small pulse width may be provided to the common sustain electrodes to erase wall charges in the cells.

The plasma display panel according to embodiment disclosed herein may employ a double protective layer to effectively reduce the discharge voltage, thereby improving the luminance and the discharge efficiency and also reducing Jitter. In addition, to prevent erroneous discharges at a low temperature, a duration in which a ramp-up waveform is applied when the plasma display panel operates at a low temperature may be set to be longer than that when it operates at a high temperature, thereby achieving stable set-up discharges.

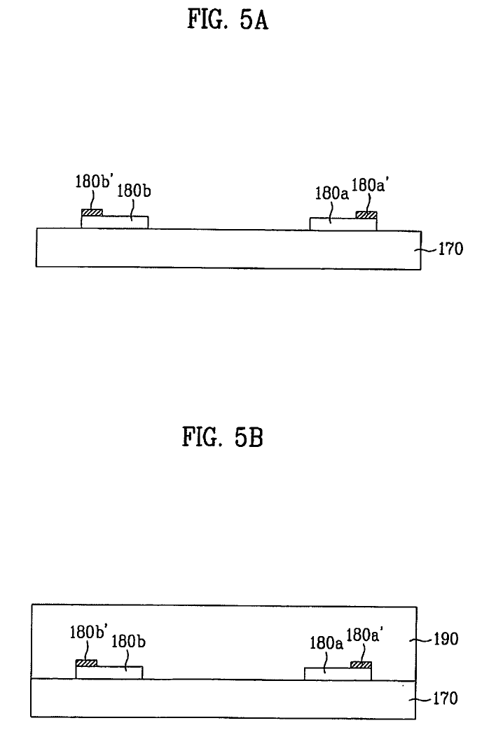

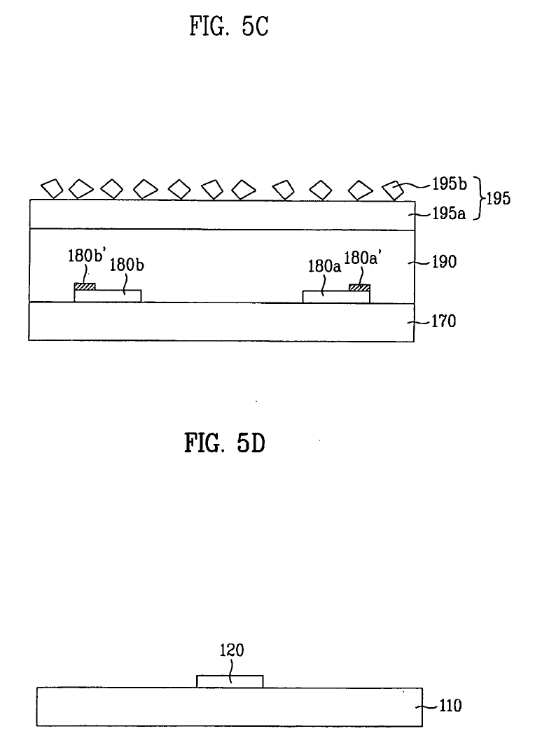

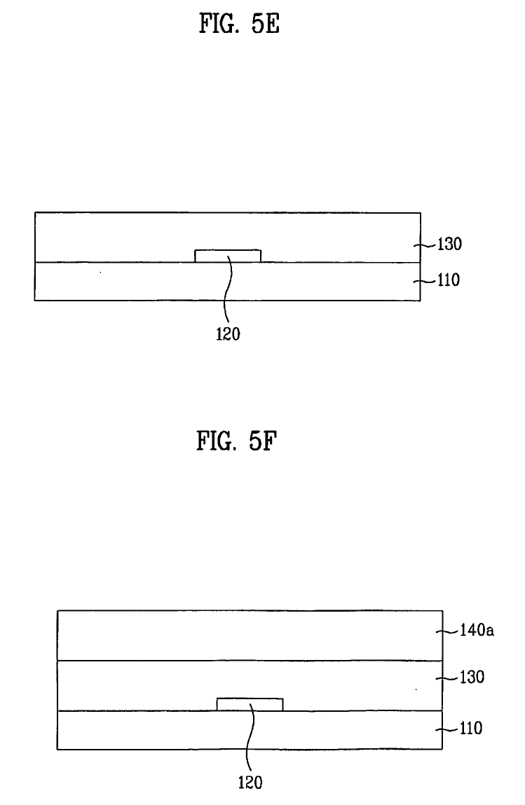

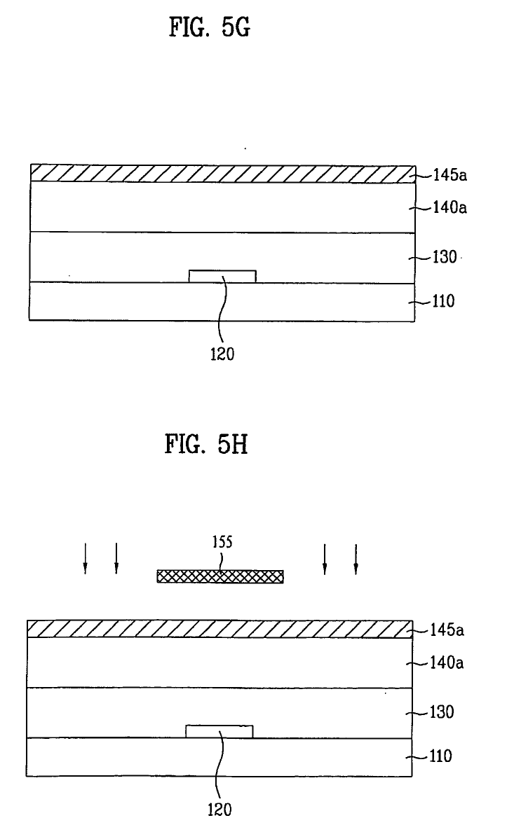

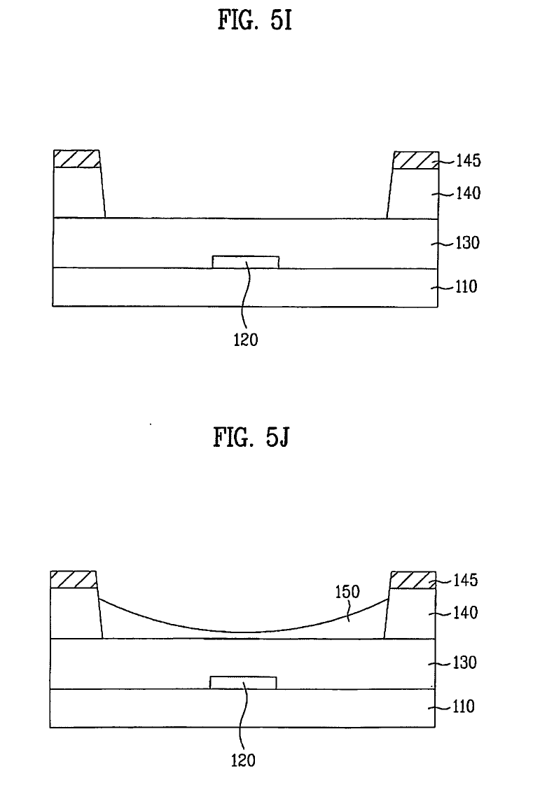

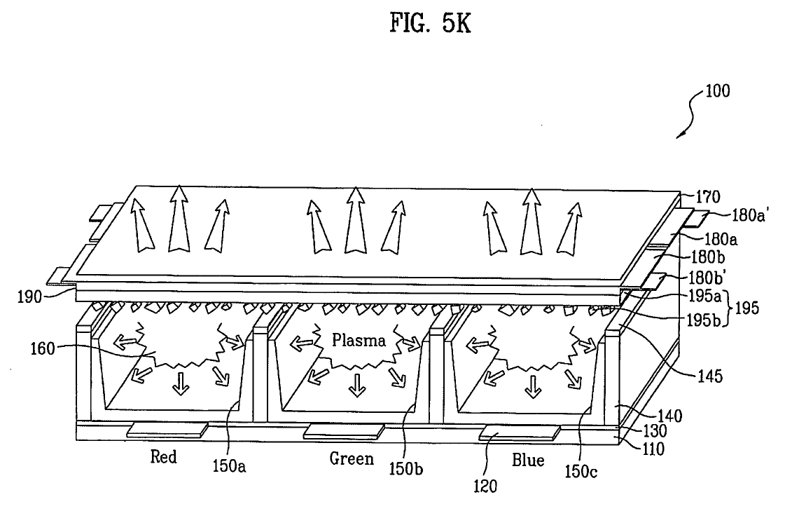

FIGS. 5A to 5K illustrate a method for manufacturing a plasma display panel according to an embodiment. Referring to FIGS. 5A to 5K, first, transparent electrodes 180a and 180b and bus electrodes 180a′ and 180b′ may be formed on a first or front panel or substrate 170, as shown in FIG. 5A. The front panel 170 may be fabricated by, for example, performing milling and cleaning on display substrate glass or soda lime glass. The transparent electrodes 180a and 180b may be formed of ITO or SnO2 by, for example, a photo-etching method using sputtering or through a lift-off method using CVD. The bus electrodes 180a′ and 180b′ may be formed of material, such as Ag, by, for example, a screen printing method, a photosensitive paste method, or similar method. A black matrix may be formed on the pair of sustain electrodes. The black matrix may be formed of low melting point glass, a black dye, or similar material by, for example, a screen printing method, a photosensitive paste method, or similar method.

Then, a dielectric layer 190 may be formed on the front panel 170 including the transparent electrodes 180a and 180b, and the bus electrodes 180a′ and 180b′, as shown in FIG. 5B. The dielectric layer 190 may be formed of a material including low melting point glass by, for example a screen printing method, a coating method, a green sheet lamination method, or similar method. The dielectric layer 190 may be formed on the front panel 70 by coating a first dielectric layer on the front panel 170 including the pair of sustain electrodes and coating a second dielectric layer having an uneven surface on the first dielectric layer.

Then, a protective layer 195 may be deposited on the dielectric layer 190, as shown in FIG. 5C. The protective layer 195 may include a first protective film 195a and a second protective film 195b. The first protective film 195a may be formed on the dielectric layer 190. The first protective film 195a may include a dopant such as silicon (Si). The first protective film 195a may be formed by, for example, a CVD method, an E-beam method, an ion-plating method, a sol-gel method, a sputtering method, or similar method. Although doping silicon in the first protective film 195a may decrease a jitter value of the address period, the jitter value may increase if the content of silicon in the first protective film 195a increases above a specific level. Accordingly, silicon may be doped in a range of concentrations minimizing the jitter value and the optimal content of silicon in the first protective film 195a may be ˜20-500 parts per million (ppm). Materials other than silicon may be used as a dopant to decrease the jitter value.

The second protective film 195b may be formed on the first protective film 195a, as shown in FIG. 5C. The second protective film 195b may include a single crystal magnesium oxide nano powder. The second protective film 195b may be formed by, for example, a CVD method, an E-beam method, an ion-plating method, a sol-gel method, a sputtering method, or similar method. The single crystal magnesium oxide nano powder may be formed by, for example, mixing a solvent, a dispersing agent, and a powder of single crystal magnesium oxide nano particles to form a liquid, milling the formed liquid, coating the liquid on a magnesium oxide film, and drying the liquid. The liquid may be coated using one of a screen printing method, a dispensing method, a photolithography method, and an ink-jet method. The single crystal magnesium oxide nano powder may be formed by providing oxide of ˜2-20 sccm and argon of ˜0-18 sccm to gaseous metal. The size of each particle of the single crystal magnesium oxide nano powder in the second protective film 195b may be ˜50-100 μm. Here, the term “size” refers to a diameter if the particle is spherical and refers to a length of one edge if the particle is hexahedral. The term “single crystal” refers to a solid object in which a crystal is repeated regularly along a crystalline axis throughout the entire volume. The single crystal is distinguished from a polycrystal that is a combination of small single crystals with different orientations.

Then, address electrodes 120 may be formed on a second or rear panel or substrate 110, as shown in FIG. 5D. The rear panel 110 may be formed by performing processes such as milling and cleaning on display substrate glass or soda lime glass. The address electrodes 120 may be formed of material, such as Ag, by, for example, a screen printing method, a photosensitive paste method, a method of photo-etching after sputtering, or similar method.

Then, a dielectric layer 130 may be formed on the rear panel 110 including the address electrodes 120, as shown in FIG. 5E. The dielectric layer 130 may be formed of material including a filler such as TiO2 and low melting point glass by, for example, a screen printing method, a green sheet lamination method, or similar method. The lower-panel dielectric layer 130 may be white to increase the luminance of the plasma display panel.

Then, barrier ribs may be formed to divide discharge cells, as shown in FIGS. 5F to 5I. The barrier rib material 140a used to form the barrier ribs may include parent glass and a filler. The parent glass may include PbO, SiO2, B2O3, and Al2O3, and the filler may include TiO2 and Al2O3.

A black top material 145a may be coated on the barrier rib material 140a, as shown in FIG. 5G. The black top material 145a may include a solvent, an inorganic powder, and an additive. The barrier rib material 140a and the black top material 145a may be patterned to form barrier ribs and black tops.

The patterning process may be performed by, for example, development after exposure with a mask. More specifically, the barrier rib material 140a and the black top material 145a may be exposed to light after arranging a mask 155 having opaque regions located at positions corresponding to the address electrodes 120, and then developed and baked so that only exposed portions of the barrier rib material 140a and the black top material 145a are left to form barrier ribs and black tops on the dielectric layer 130. Adding photoresist to the black top material may make it easy to pattern the barrier rib material and the black top material. If the black top and barrier rib materials are baked together, the binding force of the parent glass in the barrier rib material with the inorganic powder in the black top material may be increased to achieve an improvement in durability.

Then, phosphors 150 may be coated on areas of the surface of the rear panel dielectric layer 190, which may be in contact with discharge spaces, and side surfaces of the barrier ribs, as shown in FIG. 5J. Red (R), Green (G), or Blue (B) phosphors 150a, 150b, and 150c may be sequentially coated in the respective discharge cells by, for example, a screen printing method, a photosensitive paste method, or similar method.

Then, the front and rear panels 170 and 110 may be bonded together with the barrier ribs between them, as shown in FIG. 5K. After the bonded panels are sealed, impurities may be discharged out of the panels and a discharge gas 160 injected into the panels.

Then, a drive device as described above may be connected to the front and rear panels. The drive device may include a data driver, a scan driver, a sustain driver, a timing controller, a temperature sensor, and a set-down control signal generator, as shown in FIG. 2. The data driver may be connected to the address electrodes to apply data pulses to the address electrodes. The scan driver may be connected to the scan electrodes to provide a ramp-up waveform, a ramp-down waveform, a scan pulse, and a sustain pulse to the scan electrodes. The sustain driver may apply a sustain pulse and a DC voltage to the common sustain electrode.

The timing controller may control the data driver, the scan driver, the sustain driver, the temperature sensor, and the set-down control signal generator. The temperature sensor may measure an ambient temperature of the plasma display panel in operation and provide a bit signal to the set-down control signal generator. The set-down control signal generator may provide a control signal corresponding to the bit signal to the scan driver.

Other details of the plasma display panel can be found in U.S. Pat. Nos. 6,838,828 B2, 6,479,935, 6,680,573, 6,630,788, 6,621,230 B2, 6,906,690 B2, 6,791,516 B2, 6,624,587 B2, and 7,187,346, whose disclosures are incorporated herein by reference. Further, the embodiments disclosed herein can be readily applicable to display panels or plasma display panels made by various manufacturers.

As is apparent from the above description, embodiments disclosed herein provide a plasma display panel and a method for manufacturing the same, which have a variety of features and advantages. For example, the plasma display panel according to embodiments disclosed herein may employ a double protective layer to effectively reduce the discharge voltage, thereby reducing its power consumption to decrease manufacturing costs and improving luminance and discharge efficiency.

In addition, a duration in which a ramp-up waveform is applied when the plasma display panel operates at a low temperature may be set to be longer than that when it operates at a high temperature, thereby achieving stable set-up discharges. This may prevent erroneous discharges at a low temperature.

Embodiments disclosed herein are directed to a plasma display panel and a method for manufacturing the same that substantially obviate one or more problems due to limitations and disadvantages of the related art.

Embodiments disclosed herein provide a plasma display panel and a method for manufacturing the same which may effectively reduce the discharge voltage, thereby reducing its power consumption to decrease manufacturing costs and improving luminance and discharge efficiency.

Embodiments disclosed herein also provide a plasma display panel and a method for manufacturing the same, wherein a duration in which a ramp-up waveform is applied when the plasma display panel operates at a low temperature is set differently, thereby achieving stable set-up discharges and preventing erroneous discharges at low temperatures.

According to an embodiment disclosed herein, a plasma display panel is provided that includes a first panel including an address electrode, a dielectric layer, a phosphor, and a barrier rib, a second panel bonded to the first panel with the barrier rib between the first and second panels, the second panel including a pair of sustain electrodes, a dielectric layer, and a protective layer including a single crystal magnesium oxide nano powder, and a drive unit or device that provides a ramp-down waveform in a different duration according to an ambient temperature of the plasma display panel.

According to another embodiment disclosed herein, a method for manufacturing a plasma display panel is provided that includes forming an address electrode, a dielectric layer, a barrier rib, and a phosphor on a first substrate, forming a pair of sustain electrodes, a dielectric layer, and a protective layer including a single crystal magnesium oxide nano powder having the highest level of cathode luminescence in a range of 200-500 nanometer wavelengths on a second substrate, laminating the first and second substrates together, preparing a drive unit or device including a scan driver, a temperature sensor that measures temperature of the plasma display panel, and a control signal generator that generates a control signal according to an output signal of the temperature sensor and provides the control signal to the scan driver, and connecting the drive unit to the address electrode and the pair of sustain electrodes.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A plasma display panel, comprising:
a first substrate having at least one address electrode, a dielectric layer, a phosphor, and at least one barrier rib;
a second substrate positioned adjacent to the first substrate and having at least one pair of sustain electrodes, a dielectric layer, and a protective layer, the protective layer including a powder comprising single crystal metallic compound particles having a highest level of cathode luminescence in a range of approximately 300 to 500 nanometer wavelengths; and
a drive device that provides at least one of a ramp-up or a ramp-down waveform, wherein at least one of (1) the ramp-up waveform has a different peak voltage based on the temperature of the plasma display panel or (2) the ramp-down waveform has a different lowest voltage based on the temperature of the plasma display panel.

2. The plasma display panel according to claim 1, wherein the ramp-up waveform has a different peak voltage based on the temperature of the plasma display panel.

3. The plasma display panel according to claim 1, wherein the ramp-down waveform has a different lowest voltage based on the temperature of the plasma display panel.

4. The plasma display panel according to claim 1, wherein the drive device comprises:
a scan driver that provides the ramp-up waveform or the ramp-down waveform;
a temperature sensor that measures a temperature of the plasma display panel; and
a set-down control signal generator that generates a control signal according to an output signal of the temperature sensor and provides the control signal to the scan driver.

5. The plasma display panel according to claim 4, wherein the temperature sensor measures temperature of the plasma display panel and generates a different bit signal at each of a high temperature and a low temperature.

6. The plasma display panel according to claim 5, wherein the set-down control signal generator performs a control operation to allow the time when the ramp-down waveform is provided to match the bit signal.

7. The plasma display panel according to claim 5, wherein the set-down control signal generator sets a width of the control signal according to the bit signal such that a width of a control signal applied at the high temperature is narrower than a width of a control signal applied at the low temperature.

8. The plasma display panel according to claim 7, wherein the scan driver provides the ramp-down waveform during a period corresponding to the width of the control signal.

9. The plasma display panel according to claim 5, wherein the temperature sensor divides the high temperature into a plurality of temperature levels and generates a different bit signal at each of the temperature levels.

10. The plasma display panel according to claim 9, wherein the set-down control signal generator generates a control signal having a width that decreases as the temperature level increases, and wherein the scan driver provides the ramp-down waveform during a period corresponding to the -width of the control signal.

11. The plasma display panel according to claim 1, wherein the protective layer includes first and second layers, the first layer including a magnesium oxide film, the second layer being formed on the first layer and including the power comprising the single crystal metallic compound articles having the highest level of cathode luminescence in the range of approximately 300 to 500 nanometer wavelengths.

12. The plasma display panel according to claim 11, wherein particles of the powder of single crystal metallic compound particles powder are formed in groups on specific portions of the magnesium oxide film.

13. The plasma display panel according to claim 1, wherein the powder of single crystal metallic compound particles powder has a particle size of approximately 50-1000 nm.

14. The plasma display panel according to claim 1, wherein the protective layer has a degree of purity equal to or higher than approximately 95%.

15. The plasma display panel according to claim 1, wherein a dopant including crystalline oxide is added to the protective layer.

16. The plasma display panel according to claim 15, wherein the crystalline oxide is selected from the group consisting of SiO₂, TiO₂, Y₂O₃, ZrO₂, Ta₂O₅, ZnO, La₂O₃, CeO₂, Eu₂O₃, and Gd₂O₃.

17. The plasma display panel according to claim 15, wherein the crystalline oxide is alkali metal oxide or alkaline earth metal oxide.

18 The plasma display panel according to claim 15, wherein the crystalline oxide has a weight ratio of approximately 0-10% in the first layer.

19. The plasma display panel according to claim 1, wherein the dielectric layer included in the first panel has an uneven surface.

20. A plasma display panel, comprising:
a first substrate having at least one address electrode, a dielectric layer, a phosphor, and at least one barrier rib;
a second substrate positioned adjacent to the first substrate and having at least one pair of sustain electrodes, a dielectric layer, and a protective layer, the protective layer including a powder comprising single crystal metallic compound particles having a highest level of cathode luminescence in a range of approximately 300 to 500 nanometer wavelengths; and
a drive device that provide at least one of a ramp-up or a ramp-down waveform, wherein a duration of at least one of the ramp-up or ramp-down waveform is a different duration based on a temperature of the plasma display panel.

21. The plasma display panel according to claim 20, wherein the drive device comprises:
a scan driver that provides the ramp-up waveform or the ramp-down waveform;
a temperature sensor that measures a temperature of the plasma display panel; and
a set-down control signal generator that generates a control signal according to an output signal of the temperature sensor and provides the control signal to the scan driver.

22. The plasma display panel according to claim 21, wherein the temperature sensor measures temperature of the plasma display panel and generates a different bit signal at each of a high temperature and a low temperature.

23. The plasma display panel according to claim 22, wherein the set-down control signal generator performs a control operation to allow the time when the ramp-down waveform is provided to match the bit signal.

24. The plasma display panel according to claim 22, wherein the set-down control signal generator sets a width of the control signal according to the bit signal such that a width of a control signal applied at the high temperature is narrower than a width of a control signal applied at the low temperature.

25. The plasma display panel according to claim 24, wherein the scan driver provides the ramp-down waveform during a period corresponding to the width of the control signal.

26. The plasma display panel according to claim 22, wherein the temperature sensor divides the high temperature into a plurality of temperature levels and generates a different bit signal at each of the temperature levels.

27. The plasma display panel according to claim 26, wherein the set-down control signal generator generates a control signal having a width that decreases as the temperature level increases, and wherein the scan driver provides the ramp-down waveform during a period corresponding to the width of the control signal.

28. The plasma display panel according to claim 20, wherein the protective layer includes first and second layers, the first layer including a magnesium oxide film, the second layer being formed on the first layer and including the power comprising the single crystal metallic compound articles having the highest level of cathode luminescence in the range of approximately 300 to 500 nanometer wavelengths.

29. The plasma display panel according to claim 28, wherein particles of the powder of single crystal metallic compound particles powder are formed in groups on specific portions of the magnesium oxide film.

30. The plasma display panel according to claim 20, wherein the powder of single crystal metallic compound particles powder has a particle size of approximately 50-1000 nm.

31. The plasma display panel according to claim 20, wherein the protective layer has a degree of purity equal to or higher than approximately 95%.

32. The plasma display panel according to claim 20, wherein a dopant including crystalline oxide is added to the protective layer.

33. The plasma display panel according to claim 32, wherein the crystalline oxide is selected from the group consisting of SiO₂, TiO₂, Y₂O₃, ZrO₂, Ta₂O₅, ZnO, La₂O₃, CeO₂, Eu₂O₃, and Gd₂O₃.

34. The plasma display panel according to claim 32, wherein the crystalline oxide is alkali metal oxide or alkaline earth metal oxide.

35 The plasma display panel according to claim 32, wherein the crystalline oxide has a weight ratio of approximately 0-10% in the first layer.

36. The plasma display panel according to claim 20, wherein the dielectric layer included in the first panel has an uneven surface.

37. A method of driving a plasma display panel, the plasma display panel comprising a first substrate having at least one address electrode, a dielectric layer, a phosphor, and at least one barrier rib, and a second substrate positioned adjacent to the first substrate and having at least one pair of sustain electrodes, a dielectric layer, and a protective layer, the protective layer including a powder comprising single crystal metallic compound particles having a highest level of cathode luminescence in a range of approximately 300 to 500 nanometer wavelengths, the method comprising:
providing a frame having a plurality of subfields, wherein at least one sub-field has a reset period; and
providing at least one of a ramp-up waveform or ramp-down waveform during the reset period, wherein at least one of (1) the ramp-up waveform has a different peak voltage based on the temperature of the plasma display panel or (2) the ramp-down waveform has a different lowest voltage based on the temperature of the plasma display panel.

38. A method of driving a plasma display panel, the plasma display panel comprising a first substrate having at least one address electrode, a dielectric layer, a phosphor, and at least one barrier rib, and a second substrate positioned adjacent to the first substrate and having at least one pair of sustain electrodes, a dielectric layer, and a protective layer, the protective layer including a powder comprising single crystal metallic compound particles having a highest level of cathode luminescence in a range of approximately 300 to 500 nanometer wavelengths, the method comprising:
providing a frame having a plurality of subfields, wherein at least one sub-field has a reset period; and
providing at least one of a ramp-up waveform or ramp-down waveform during the reset period, wherein the duration of at least one of the ramp-up or ramp-down waveform is a different duration based on a temperature of the plasma display panel.
